(19) United States
(12) Patent Application Publication
(10) Pub. No.: US 2007/0171409 A1
(43) Pub. Date: Jul. 26, 2007

(54) Method and apparatus for dense spectrum unmixing and image reconstruction of a sample

(76) Inventors: Xinghua Wang, Pittsburgh, PA (US); Thomas C. Voigt, Export, PA (US)

Correspondence Address: DUANE MORRIS LLP, 1667 K. STREET, N.W., SUITE 700, WASHINGTON, DC, 20006-1608, US

(21) Appl. No.: 11/649,293

(22) Filed: Jan. 4, 2007

Related U.S. Application Data
(60) Provisional application No. 60/756,124, filed on Jan. 4, 2006.

(51) Int. Cl. G01J 3/40

(52) U.S. Cl. 356/304

(57) ABSTRACT

In one embodiment, the disclosure relates to a method including: collecting photons from the sample having a plurality of regions to form a sample optical data set; selectively transmitting a first portion of the optical data set through a first of a plurality of apertures of an electro-optical shutter, each of the plurality of apertures optically communicating a portion of the optical data set; geometrically conforming the first portion of the optical data set for communication with a spectrometer opening; processing the conformed first portion of the optical data set at the spectrometer to obtain a spectrum for a first of the plurality of sample regions.

The instant disclosure claims the filing-date benefit of Provisional Application No. 60/756,124, filed Jan. 4, 2006, entitled “Dense Spectral Unmixing and Image Reconstruction (DSUIR)”, the disclosure of which is incorporated herein by reference in its entirety. Cross-reference is made to patent applications filed simultaneously herewith and entitled “Method and Apparatus for Dense Spectrum Unmixing and Image Reconstruction of a Sample” (Attorney Docket No. CHE01 118) the specification of each of the cross-referenced applications being incorporated herein in its entirety.

### BACKGROUND

Spectral analysis of a sample requires illuminating the entire sample and obtaining spectral information therefrom. For samples having a mixture of substances, spectral unmixing includes obtaining independent spectra for various regions of interest of the sample. Thus, the sample must be divided into regions of interest and each region is independently analyzed.

Conventional spectral unmixing techniques fall into one of three general techniques. The first technique is point-scanning and operates by illuminating the sample at a first region (a point) to obtain the spectral image of the region before repeating the illumination/scanning at a second region. For efficiency, the regions are selected such that each region is adjacent to the previously-scanned region. The point-scanning technique is time-consuming and inefficient. Moreover, the point scanning technique is impractical where, for instance, the sample is in vivo and moving the illumination source, the sample or the gathering optics is not practical.

A second technique is the line-scan technique and operates by illuminating a line (e.g., a row or a column) on the sample at a time. Here, the illumination source excites all substances on the illuminated line and obtains the spectra for the illuminated region. The operation is repeated for the subsequent line until the entire sample is illuminated. This technique is time-consuming and inefficient.

The third technique is the wide-field illumination which allows illuminating the entire sample at once. The optical signal collected from the sample is communicated to an optical filter such as a liquid crystal tunable filter (“LCTF”) which receives the entire field of view of the sample but only processes one wavelength at a time. This techniques is time consuming as only one wavelength can be processed during any given time interval. In addition, it does not enable sampling a particular region of the entire field of view.

Other miscellaneous techniques provide mechanical devices which move the sample, the illumination source or both. These techniques have moving parts which are also inefficient and, at times, impractical.

### SUMMARY OF THE DISCLOSURE

In one embodiment, the disclosure relates to a method comprising: collecting photons from the sample having a plurality of regions to form a sample optical data set; selectively transmitting a first portion of the optical data set through a first of a plurality of apertures of an electro-optical shutter, each of the plurality of apertures optically communicating a portion of the optical data set; geometrically conforming the first portion of the optical data set for communication with a spectrometer opening; processing the conformed first portion of the optical data set at the spectrometer to obtain a spectrum for a first of the plurality of sample regions.

In another embodiment, the disclosure relates to a method comprising: collecting photons from a sample having a plurality of regions to form a sample optical data set; transmitting the optical data set through a plurality of apertures of an electro-optical shutter to a spectrometer to form a spectral image of the sample; selecting a first region of interest from said spectral image; selectively transmitting a first portion of the optical data set through a first group of apertures among the plurality of apertures, the first group of apertures communicating with the first region of interest; and processing the first portion of the optical data set at the spectrometer to obtain a spectrum for the first region of interest.

In another embodiment, the disclosure relates to a system comprising: a first optical train for collecting photons from a sample having a plurality of regions and forming a sample image; an electro-optical shutter having a plurality of apertures, each aperture optically communicating with one of the plurality of sample regions to provide an optical data set for each corresponding region; a second optical train for receiving and geometrically conforming the optical data set for each region and communicating said optical data set to a spectrometer opening; and a spectrometer for processing the conformed optical data set for each region to obtain a spectrum for the region.

In still another embodiment, the disclosure relates to a system comprising: a processor for receiving a sample spectrum and identifying presence of a first substance at each of a first and a second region from among a plurality of sample regions; an electro-optical shutter having a plurality of apertures, each aperture communicating an optical signal with one of the plurality of sample regions; a controller for receiving instructions from the processor to: (a) locate the first region and the second region from among the plurality of sample regions, (b) identify a first aperture corresponding to the first region and a second aperture corresponding to the second region, (c) communicate a first optical signal from the first region through the first aperture and communicate a second optical signal from the second region through the second aperture; a spectrometer for receiving the first optical signal and the second optical signal and forming a combined optical signal for the first substance.

### BRIEF DESCRIPTION OF THE DRAWINGS

These and other embodiments of the disclosure will be discussed in relation to the following non-limiting and exemplary drawings in which:

FIG. 1 represents of a conventional hand-held spectroscopy device;

FIG. 2 shows a sample having various regions of interest;

FIG. 3 is a system for spectral unmixing and image reconstruction according to one embodiment of the disclosure;

FIG. 4A shows an exemplary system for geometrically conforming a sample image along the x-axis;

FIG. 4B shows an exemplary system for geometrically conforming the image of FIG. 4A along the y-axis;

FIG. 5 shows different regions of interest of a sample through a shutter and a CCD detector;

FIG. 6A shows an exemplary reflective liquid crystal shutter;

FIG. 6B shows an exemplary transmissive liquid crystal shutter;

FIG. 6C shows an exemplary digital light processing chip for use as a shutter;

FIG. 7 shows an exemplary implementation of a transmissive shutter according to one embodiment of the disclosure;

FIG. 8A shows an exemplary implementation of a reflective shutter according to one embodiment of the disclosure;

FIG. 8B shows an exemplary implementation of a reflective shutter according to another embodiment of the disclosure;

FIG. 9 is an exemplary algorithm for spectral unmixing according to one embodiment of the disclosure; and

FIG. 10 is an exemplary structure for signal detection and image reconstruction according to one embodiment of the disclosure.

### DETAILED DESCRIPTION

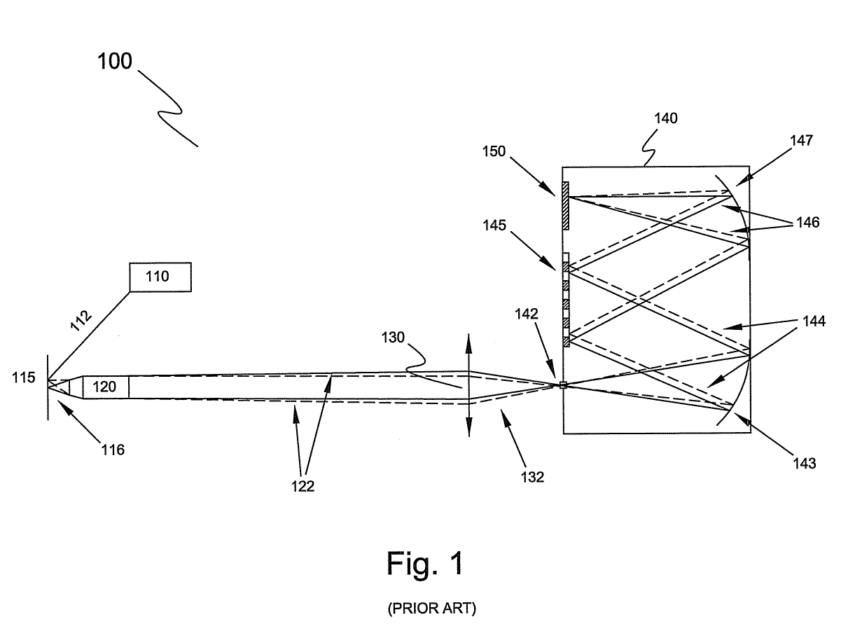

FIG. 1 represents of a conventional hand-held spectroscopy device. System 100 of FIG. 1 can be a handheld Raman spectrometer. Laser illumination source 110 provides illuminating photons 112 to sample 115. Laser illumination source can operate as a point-scan or a line-scan system. Sample-scattered photons 116 can be Raman scattered photons. Alternatively, photons 116 can be reflected, refracted, luminescence, fluorescence, Raman scattered, transmitted, absorbed, and emitted by the sample.

Objective lens 120 receives and collects photons 116. Objective lens 120 can also define an optical train configured to receive photons 116 and form a sample optical data set 122 therefrom. Lens 130 receives sample optical data set 122 and reduces the field of view of the optical data set 122 to a size 132 compatible with spectrometer opening or slit 142 of dispersive spectrometer 140. In spectrometer 140, reflective mirror 143 communicates the reduced field of view 132 of the optical data set 122 to reflection grating array 145. Grating 145 disperses optical signals 144 into multiple spectral orders 146, which are in turn directed through reflective mirror 147 to illuminate charge-coupled device 150.

While illumination source 110 may illuminate the entire sample at once, the spectrum can only be collected at a specific point or location of the sample. To obtain a spectrum of another region of the sample, the illumination source 110, sample 115 or both must be moved. This procedure is time-consuming and inefficient.

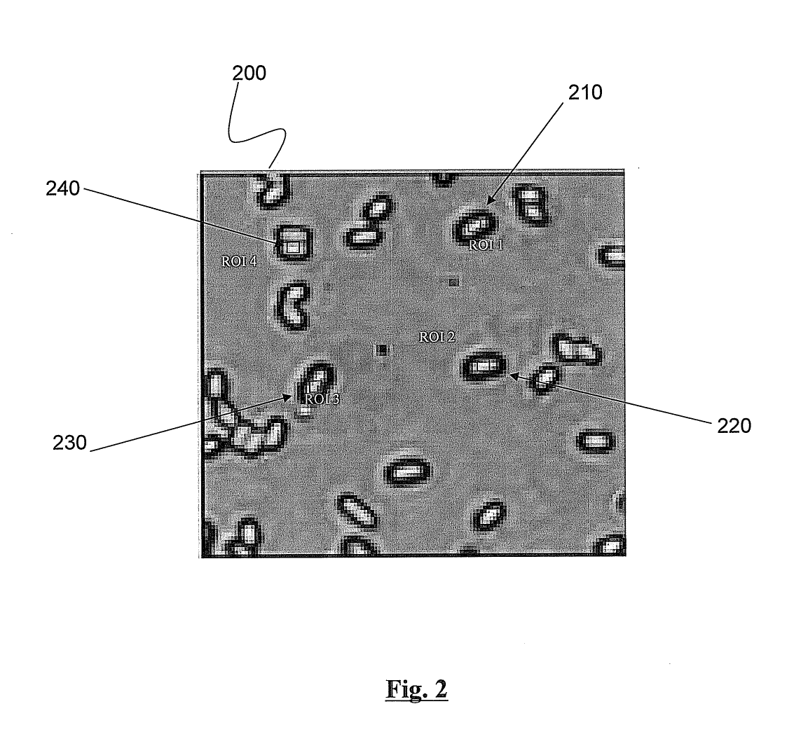

FIG. 2 shows a sample having various regions of interest. Specifically, sample 200 is shown with four regions of interest (ROI) 210, 220, 230 and 240. Sample 200 can define a chemical, a biological, a bio-chemical substance under study. Each of the regions 210, 220, 230 and 240 can have one or more optical properties that defines a particular chemical or biological attribute. For example, region 210 may provide a particular Raman scattering indicating presence of cancerous cells. Each of the remaining regions of interest 220, 230 and 240 can provide a similar Raman spectra as region 210 signifying the presence of similar cells. Thus, it may be desirable to detect presence of cancerous cells, identify corresponding regions of interest with cancerous cells (i.e., regions 210, 220, 230 and 240) and obtain a Raman spectrum for each of the regions of interest. While the conventional point-scanning system enables (e.g., system 100 of FIG. 1) detecting an exclusive signal from region 240, scanning the entire sample first and then focusing on region 240 can be time-consuming. Similarly, line-scanning techniques do not allow focusing on region 240.

Alternatively, regions 210, 220 and 230 can comprise a first chemical substance with a corresponding chemical spectrum. The presence of the first chemical substance throughout the sample 200 may be such that its spectral signal overwhelms a weaker signal from a second substance at region 240. Therefore, it may be desirable to study the chemical spectrum of region 240 without receiving interference from regions 210, 220 and 230. As stated, conventional detection system, such as system 100 of FIG. 1 do not adequately address this need.

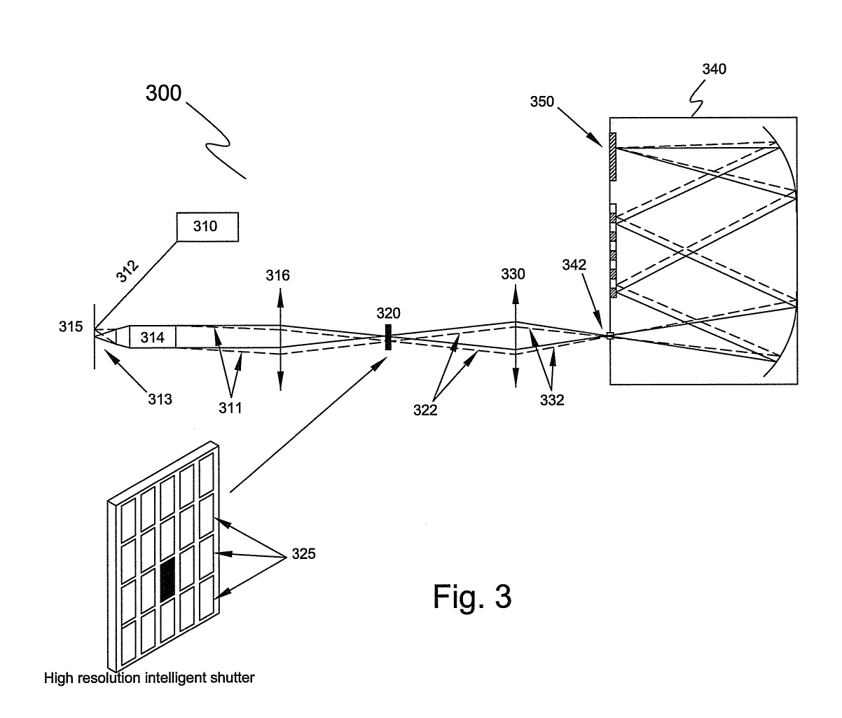

FIG. 3 is a system for spectral unmixing and image reconstruction according to one embodiment of the disclosure. In FIG. 3, system 300 can be a handheld device with an integrated illumination source or a stationary device. Illumination source 310 provides illuminating photons 312 to sample 315. Illumination photons 312 can illuminate the entire sample simultaneously. Illumination photons 312 can excite the sample to provide, for example, reflected, refracted, luminescence, fluorescence, Raman scattered, transmitted, absorbed, or emitted photons 313.

Objective lens 314 receives and collects sample photons 316. Objective lens 314 can also define an optical train configured to receive sample photons 313 and form a sample optical data set having field of view 311. Lens 316 receives and focuses field of view of optical data set 311 to a size compatible for communication with shutter 320. Shutter 320 can comprise a solid state electro-optical device having a two-dimensional array of controllable apertures 325. Thus, shutter 320 can communicate selective portions of the sample's field of view by selectively and independently opening one more of the appropriate apertures 325. Moreover, shutter 320 can be electronically controlled by a processor (not shown) to thereby operate without any mechanical or moving parts.

Selective portions of the optical data set 322 corresponding to one or more regions of interest can be optically transmitted through shutter 320 while blocking optical transmission from the remaining regions of the sample. In one embodiment, each aperture 325 of shutter 320 correspond with a particular region of sample 315. Thus, an optical data set communicated through a particular aperture 325 can define the optical image (or spectrum) from the corresponding region of sample 315.

The selected portions of optical data set 322 can be processed by lens 330 to geometrically conform the selected portions of data set 332 for optical communication with slit 342 of spectrometer 340. The step of geometrically conforming can comprise expanding or contracting the selected portions of optical data set 322 in one or more directions. The geometrically-conformed portions of the optical data set can be processed at spectrometer 340 and CCD 350 to obtain a spectrum for the selected sample region.

In one embodiment, all apertures 325 can be enabled simultaneously to communicate and to form an image of the sample at the CCD. Thus, the field-of-view (FOV) of CCD 350 can comprise the entire image of sample 315. In another embodiment, a single aperture can be enabled to optically communicate optical data set of a select region of the sample with spectrometer 340. According to this embodiment, the FOV at the CCD comprises only the image of the selected region.

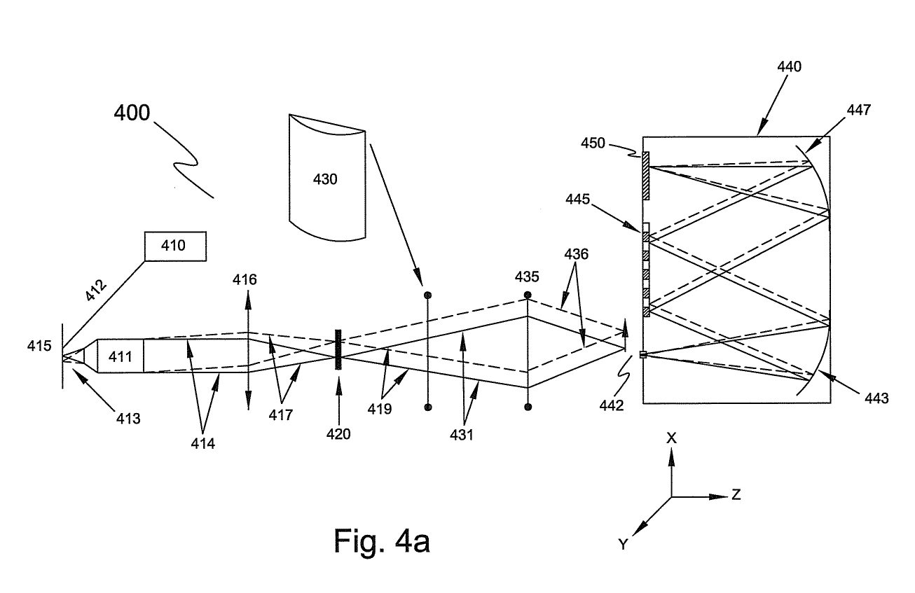

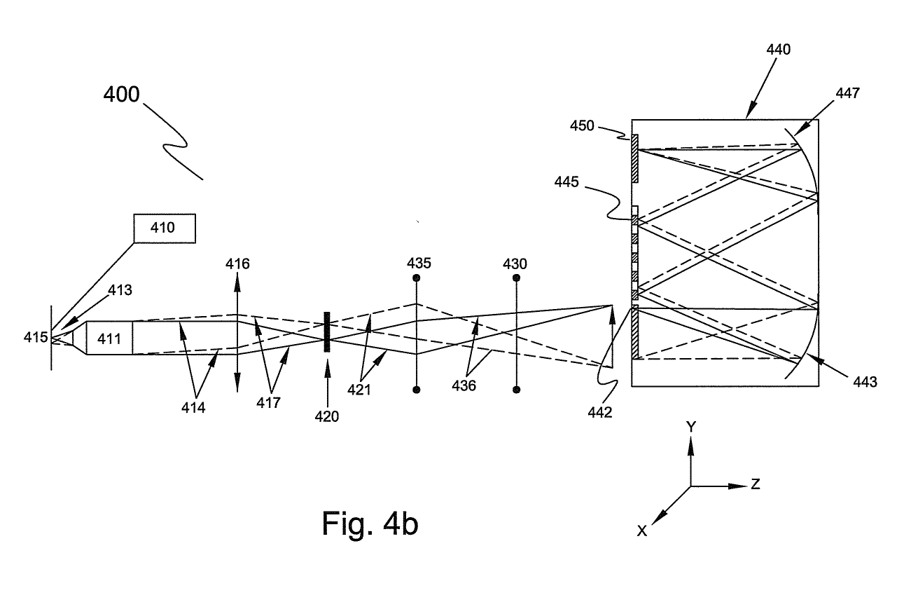

FIG. 4A is a system for spectral unmixing and image reconstruction along the x-axis according to an embodiment of the disclosure. In system 400 of FIG. 4A, illumination source 410 illuminates sample 415. Illumination photons 412 excite sample 415 to provide sample photons 413. First optical train 411 can focus sample photons 413 to provide an optcal data set for the entire sample 414. Lens 416 focuses optical data set 414 into a FOV 417 adapted for electro-optical shutter 420. Electro-optical shutter 420 can comprise multiple apertures (not shown) for optically communicating one or more portions of sample optical data set corresponding to one or more regions of sample 415.

Conventional spectrometers have a long and narrow spectrometer opening or slit. Such slits are typically narrow along the X-axis and wide on the Y-axis. Therefore, any optical communication between shutter 420 and spectrometer 440 may include one or more optical lenses for geometrically conforming the FOV of optical data set 419 transmitted through shutter 420. The geometric conformation may be non-uniform. That is, the geometric conformation of the optical data set may contract the data set in one direction while expanding the data set in another direction. Moreover, the geometric conformation can be configured to communicate the entire optical data set without losing any optical information.

To this end, FIG. 4A shows an exemplary embodiment where cylindrical lenses 430 and 435 are positioned to geometrically conform the field of view of optical data set 419 to fit slit 442 of spectrometer 440. To this end, cylindrical lens 430 conforms FOV of optical data set 419 in the x-direction and cylindrical lens 435 conforms optical data set 431 in the y-direction. Cylindrical lenses 430 and 435 can define an optical train which functions to geometrically conform optical data set 419 to the desired shape. Such optical train can include two cylindrical lenses as shown in FIGS. 4A and 4B. Alternatively, the optical train can include a prism interposed between two objective (concave) lenses or a cylindrical lens and one or more objective lenses. At spectrometer 440, image 436 is directed through collimation mirror 443, grating 445 and focusing mirror 447 to form an image at CCD 450.

As stated, the optical data set may be geometrically conformed in at least two directions before it can be received at spectrometer slit 442. FIG. 4B shows an exemplary system for geometrically conforming the image of FIG. 4A along the y-axis. In FIG. 4B, the placement of cylindrical lenses 430 and 435 has been shifted for illustration purposes. Cylindrical lens 435 receives optical data set 431 and conforms it along the Y-axis to form conformed optical data set 436 for optical communication with spectrometer slit 442. At spectrometer 440, conformed optical data set 436 is directed through collimation mirror 443, grating 445 and focusing mirror 447 to form an image at CCD 450. Depending on the geometric conformation, similar collimation mirror 443 and focusing mirror 447 can be used for images conformed in the X- and the Y-axis.

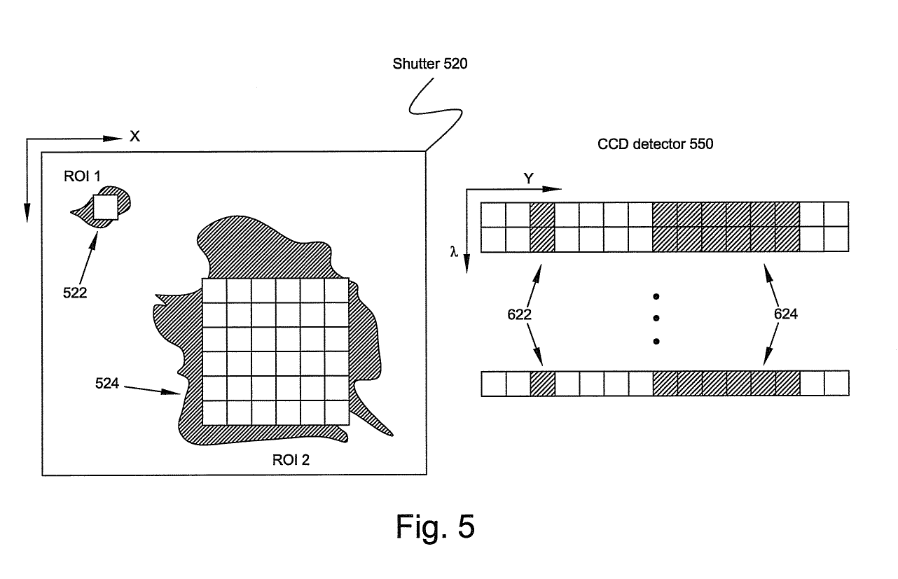

FIG. 5 shows different regions of interest of a sample through a shutter and a CCD detector. In FIG. 5, shutter 520 is shown with a subset of apertures corresponding to two different regions of interest on a sample (not shown). The first region of interest (ROI 1) 522 corresponds to a first region of the sample and the second region of interest (ROI 2) 524 corresponds to a second region of interest on the sample. As seen in FIG. 5, the second region of interest is significantly larger than the first region of interest. According to one embodiment of the disclosure, once each of the first and the second regions of interest has been identified a corresponding subset of apertures (522, 524) is enabled to communicate optical signals from each region. Further, the remaining apertures of shutter 520 (not shown) can be disabled to block optical signal communication from the remaining regions of the sample. The optical signals from the first and the second regions of interest are directed through apertures 522 and 524 to CCD detector 550 and are received at array detectors 622 and 624, respectively. The energy of the optical signal for each region of interest can be appropriately measured and reported.

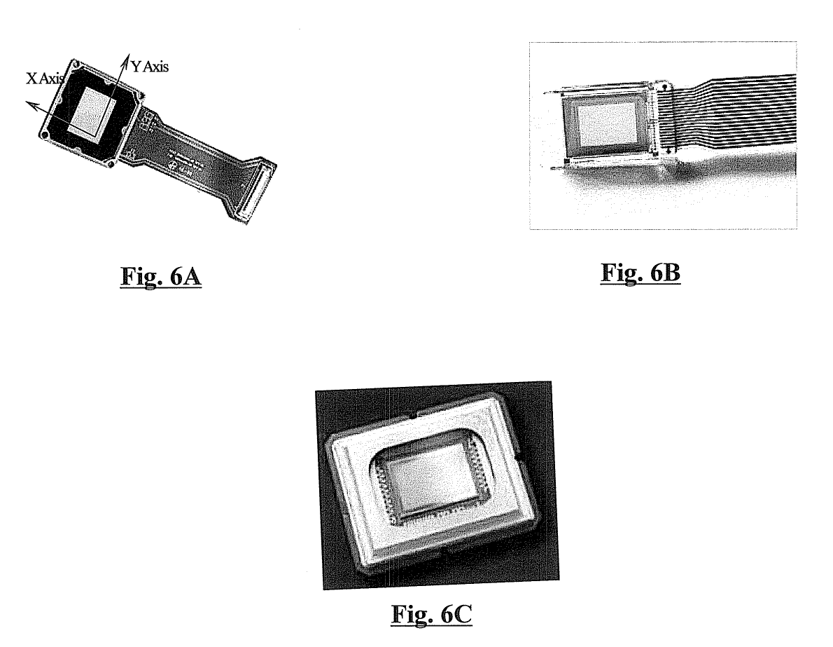

The embodiments of the disclosure can be implemented with transmissive shutters, reflective shutters or a combination thereof. For example, FIG. 6A shows an exemplary reflective liquid crystal on silicon shutter having 99% filling factor and providing polarization independent transmission. Such shutters provide efficient use of pixel aperture. FIG. 6B shows an exemplary transmissive liquid crystal on silicon shutter having 70% filling factor and providing polarization-dependent transmission. FIG. 6C shows an exemplary digital light processing (DLP) chip for use as a shutter. The exemplary DLP chip of FIG. 6C provides +/−10% mirror tilt and greater than 90% filling factor. The DLP chip can be polarization independent. The electro-optical shutters of FIGS. 6A-6C are exemplary and other electro-optical devices can be used without departing from the principles of the disclosure.

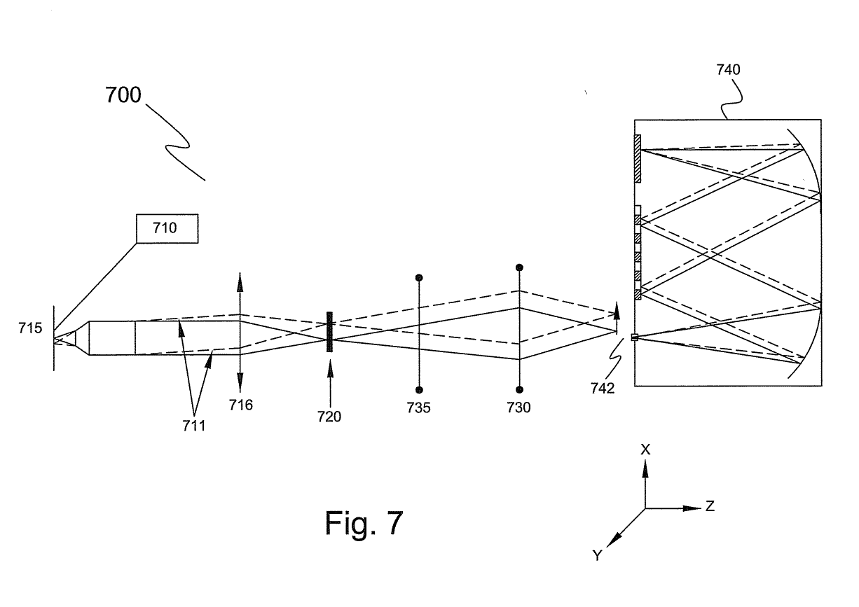

FIG. 7 shows an exemplary implementation of a transmissive shutter according to one embodiment of the disclosure. In FIG. 7, illumination source 710 of system 700 illuminates sample 715 to produce optical data set 711 of sample 715. Optical data set 711 is focused through objective lens 716 for communication with transmissive shutter 720. Cylindrical lenses 730 and 735 are configured to geometrically conform the sample optical data set to a size adapted for slit 742 of spectrometer 740.

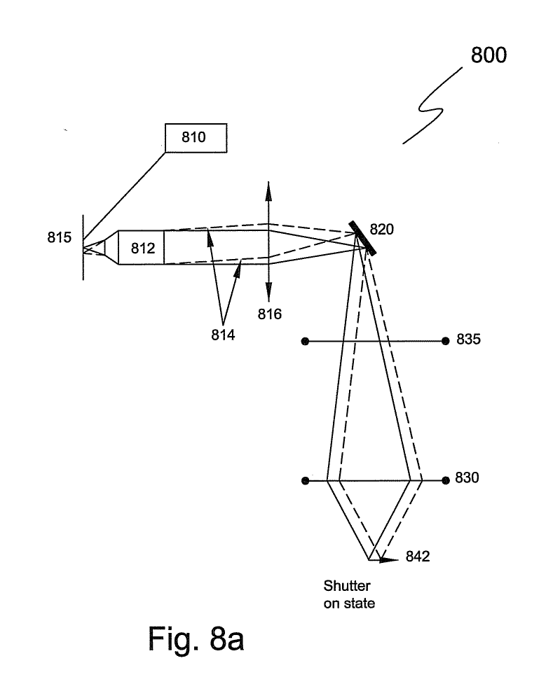

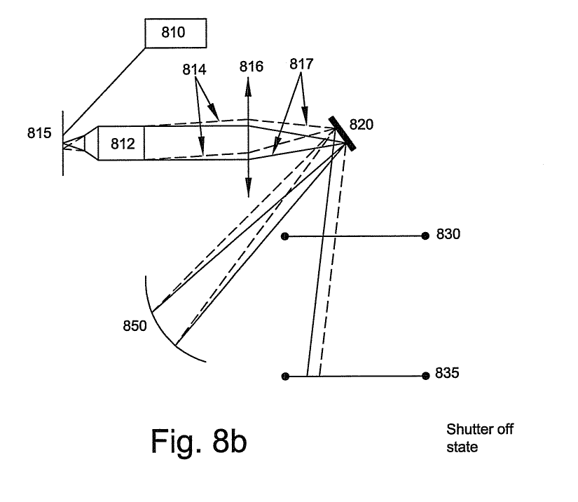

FIG. 8A shows an exemplary implementation of a reflective shutter according to one embodiment of the disclosure. Specifically, FIG. 8A shows system 800 having reflective shutter on state 820. Illumination source 810 illuminates sample 815 with photons to produce sample photons. Sample photons are collected by optical train 812. Sample optical data set 814 having a field of view is then received at objective lens 816 which focuses the filed of view of optical data set 814 onto reflective shutter 820. Reflective shutter 820 can comprise a plurality of apertures (not shown) for selectively communicating a portion of optical data set 814, corresponding to a region of interest, to lenses 835 and 830. Reflective shutter 820 can be a DLP shutter having two states: on-state and off-state. At the on-state the digital mirror is at +15° and at the off-state the digital mirror is −15° off center. Lenses 835 and 830 can comprise cylindrical lenses combined to form a second optical train. Lenses 835 and 830 can geometrically conform an optical signal from shutter 820 for communication with spectrometer slit 842.

FIG. 8B shows an exemplary implementation of a reflective shutter according to another embodiment of the disclosure. As in FIG. 8A, illumination source 810 illuminates sample 815 with photons to produce sample photons. Sample photons are collected by first optical train 812 and an optical data set 814 having a FOV is formed. Objective lens 816 focuses the FOV of optical data set 814 onto off-state shutter 820. Reflective shutter 820 can comprise a plurality of apertures (not shown) for selectively communicating a portion of optical data set 817 corresponding to one or more regions of interest of sample 815. As shown in FIG. 8B, shutter 820 directs selective portions of optical data set 817 to region 850 while transmitting the remaining portions (not shown). Thus, the shutter deflect the unwanted regions of the sample's optical data set to region 850 while reflecting the regions of interest to lenses 830 and 835.

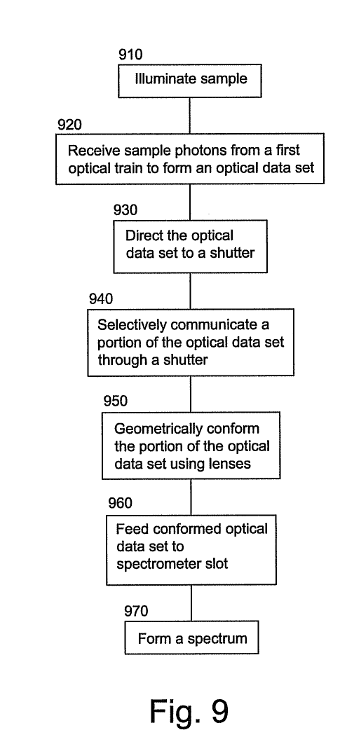

FIG. 9 is an exemplary algorithm for spectral unmixing according to one embodiment of the disclosure. In step 910, the sample is illuminated with photons to produce sample photons. Sample photons can comprise photons reflected, refracted, luminescence, fluorescence, Raman scattered, transmitted, absorbed, and emitted by the sample. In step 920, the sample photons are collected by an optical train to form an optical data set for the sample. In step 930, a lens is used to focus and direct the optical data set to a shutter. The lens can be an objective lens or any other optical means configured to focus the sample's optical data set onto a shutter.

The shutter can be an electro-optical shutter having a plurality of apertures dispersed in different dimensions. In one embodiment of the disclosure, each aperture is configured to optically communicate with a corresponding region of the sample. Thus, a region of interest can be selectively identified by allowing optical communication through a corresponding aperture. The optical communication can be enabled for a plurality of regions of interest simultaneously or sequentially (step 940). In another embodiment, all apertures can be simultaneously enabled to provide optical data set for the entire sample at once. Thus, the entire sample can be studied to identify one or more regions of interests. Once such regions of interest have been identified, select apertures corresponding to the regions of interest can be enabled to obtain a plurality of images corresponding to the regions of interests. Advantageously, the entire operation can be implemented without changing the illumination source, moving the sample or the illumination source or mechanically manipulating the apertures of the shutter.

In step 950, a plurality of lenses (collectively, a second optical train) can be used to geometrically conform the select portion of the optical data set. The geometrically conforming step can be optionally implemented. The optical data set communicated through the shutter is then directed to a spectrometer slit (step 960). In one embodiment, the image is further conformed to fit the spectrometer slit in order to avoid optical signal loss. Finally, in step 970 one or more spectra is formed from the optical signal. The spectra can depict a region of interest, a plurality of regions of interest or the entire sample. Depending on the spectra, steps 910-970 may be repeated for subsequent regions of interests.

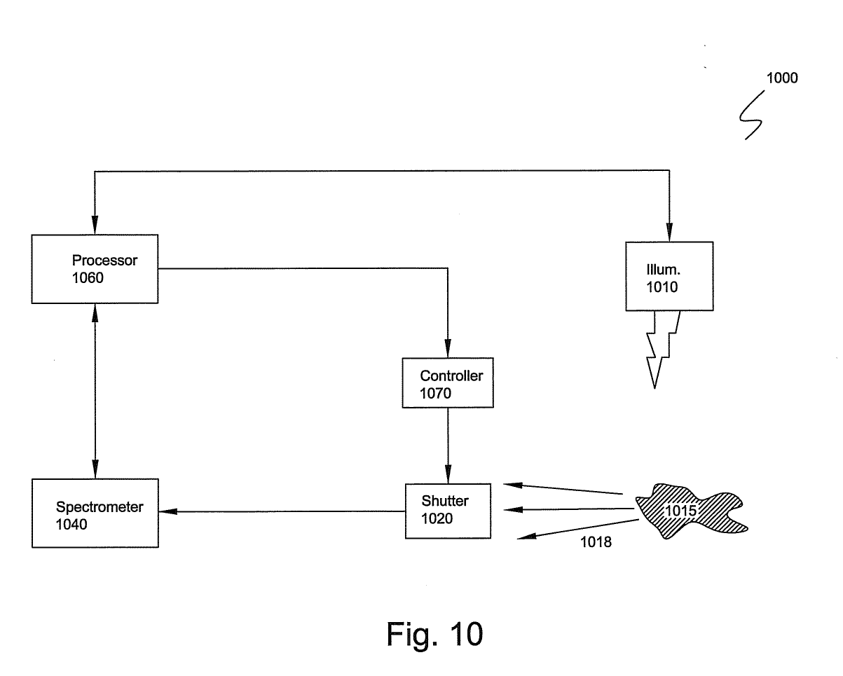

FIG. 10 is an exemplary system for signal detection and image reconstruction according to one embodiment of the disclosure. In system 1000, sample 1015 is illuminated by illumination source 1010. Illumination source 1010 can be any source appropriate for making a Raman, fluorescence, visible absorption/reflectance, infrared (IR) absorption/reflectance and/or near IR absorption/reflectance measurement. Once illuminated, sample photons 1018 are directed to shutter 1020. Shutter 1020 can comprise a plurality of apertures wherein each aperture optically communicates with a particular region of sample 1015. Shutter 1020 provides optical signals (i.e., optical data set) from one or more regions of sample 1015 to spectrometer 1040. Spectrometer 1040 may include additional optical components such as CCD, LCTF, etc.

Spectrometer 1040 can communicate with processor 1060. For example, processor 1060 can receive spectra or optical images from spectrometer 1040. Based on information received from spectrometer 1040, processor 1060 can determine the subsequent action of system 1000. For example, processor 1060 can instruct illumination source 1010 to illuminate sample 1015 with photons of different wavelength for a subsequent measurement. The communication between processor 1060 and illumination source 1010 can be duplex. That is, illumination source 1010 can report its illumination wavelength to processor 1060.

Processor 1060 can control apertures of shutter 1020 either directly or through controller 1070. Controller 1070 can define a DC/DC converter or any other electronic circuitry for enhancing communication between processor 1060 and shutter 1020. In another embodiment (not shown), processor 1060 communicates directly with shutter 1020.

In an exemplary implementation, processor 1060 receives a spectra from spectrometer 1040 and determines a first and a second regions of interest in sample 1015. Processor 1060 can then determine the location of the first and the second regions of interest in sample 1015 and a corresponding first and second apertures. Next, controller 1060 can direct controller 1070 to enable the first and the second apertures of shutter 1020 while disabling (i.e., blocking) signal communication through the remaining apertures of shutter 1020. In one implementation, the first aperture is enabled independently of the second aperture to communicate an optical signal of the first region of interest. Subsequently, the second aperture is enabled independently of the first aperture to communicate an optical signal of the second region of interest. In another implementations, the first and the second apertures are enabled simultaneously to communicate optical signals of the first and the second apertures simultaneously.

Spectrometer 1040 can form spectra for the first and the second regions of interest and communicate the spectra to processor 1060. Processor 1060 can then identify a third region of interest of sample 1015 along with its corresponding aperture and direct system 1000 to obtain a spectrum for the third region of interest. The process can continue iteratively to compile the desired spectra from sample 1015.

In another implementation, processor 1060 can receive an initial spectrum of sample 1015 from spectrometer 1040. From the initial spectrum, the processor can identify a region of interest having a weaker optical signal overwhelmed by the optical signal from its surrounding regions. Processor 1060 can direct controller 1070 to disable optical communication from the surrounding regions so as to allow spectrometer 1040 to receive a stronger optical signal from the region of interest.

The above description is not intended and should not be construed to be limited to the examples given but should be granted the full breadth of protection afforded by the appended claims and equivalents thereto. Although the disclosure is described using illustrative embodiments provided herein, it should be understood that the principles of the disclosure are not limited thereto and may include modification thereto and permutations thereof.

What is claimed is:

1. A method comprising:
collecting photons from a sample having a plurality of regions to form an optical data set;
selectively transmitting a first portion of the optical data set through a first of a plurality of apertures of an electro-optical shutter, each of the plurality of apertures optically communicating a portion of the optical data set;
geometrically conforming the first portion of the optical data set for communication with a spectrometer opening;
processing the conformed first portion of the optical data set at the spectrometer to obtain a spectrum for a first of the plurality of sample regions.

2. The method of claim 1, wherein the step of collecting photons from the sample further comprises illuminating the sample with photons to produce sample photons.

3. The method of claim 1, wherein the step of selectively transmitting the first portion of the optical data set further comprises blocking transmission of a remaining portion of the optical data set.

4. The method of claim 1, wherein the electro-optical shutter is a solid state optical device having a two-dimensional array of apertures.

5. The method of claim 1, further comprising obtaining a spectrum of a second of the plurality of sample regions by selectively transmitting a second portion of the optical data set through a second aperture.

6. The method of claim 5, wherein the first sample region and the second sample region are spatially separated.

7. The method of claim 5, wherein the first sample region and the second sample region form a contiguous column of the sample.

8. The method of claim 5, wherein the first sample region and the second sample region have a substantially similar spectrum.

9. The method of claim 5, wherein the step of selectively transmitting a first portion and the second portion of the optical data set further comprises blocking transmission of a remaining portion of the optical data set.

10. The method of claim 5, further comprising forming a spatially accurate wavelength resolved image from the first and the second spectra.

11. The method of claim 5, further comprising simultaneously transmitting the first portion and the second portion of the optical data set through the first and the second apertures.

12. The method of claim 5, further comprising transmitting the first portion of the optical data set through the first aperture before transmitting the second portion of the optical data set through the second aperture.

13. The method of claim 5, wherein the first and the second regions of interest define a substance in the sample.

14. The method of claim 5, further comprising combining the first and the second optical data set to form a combined spectrum for the first and the second regions.

15. The method of claim 1, wherein the step of geometrically conforming the first portion of the optical data set further comprises at least one of contracting or expanding a field of view of the optical data set in at least one direction.

16. The method of claim 1, wherein the spectrometer opening is a slit.

17. The method of claim 1, wherein the photons collected from the sample are photons reflected, refracted, luminescence, fluorescence, Raman scattered, transmitted, absorbed, and emitted by the sample.

18. The method of claim 1, wherein the shutter is one of a transmissive shutter or a reflective shutter.

19. The method of claim 1, wherein the step of geometrically conforming the first portion of the optical data set further comprises using a combination of lenses selected from the group consisting of a cylindrical lens, a prism and a concave lens.

20. A system comprising:
a first optical train for collecting photons from a sample having a plurality of regions and forming a sample image;
an electro-optical shutter having a plurality of apertures, each aperture optically communicating with one of the plurality of sample regions to provide an optical data set for each corresponding region;
a second optical train for receiving and geometrically conforming the optical data set for each region and communicating said optical data set to a spectrometer opening; and
a spectrometer for processing the conformed optical data set for each region to obtain a spectrum for the region.

21. The system of claim 20, further comprising an illumination source for illuminating the sample with photons to produce sample photons.

22. The system of claim 20, wherein the first optical train further comprises one or more objective lenses for collecting photons from the sample.

23. The system of claim 20, wherein the electro-optical shutter is a solid state optical device having a two-dimensional array of controllable apertures.

24. The system of claim 20, wherein the electro-optical shutter is selected from the group consisting of reflective liquid crystal on silicon, transmissive liquid crystal on silicon and digital light processing chip.

25. The system of claim 20, wherein the electro-optical shutter is configured to optically communicate with a select one of the plurality of sample regions by transmitting photons from the corresponding region of the sample.

26. The system of claim 20, wherein the electro-optical shutter is configured to optically communicate with a select one of the plurality of sample regions by blocking photons transmitted from a non-selected region of the sample.

27. The system of claim 20, wherein the electro-optical shutter is configured to optically communicate with a select plurality of sample regions simultaneously.

28. The system of claim 20, further comprising an image sensor for forming a spatially accurate wavelength resolved image from the optical data set collected from the plurality of sample regions.

29. The system of claim 28, wherein the image sensor is a charge-coupled device.

30. The system of claim 20, wherein the second optical train further comprises a plurality of lenses for contracting or expanding the optical data set in at least one direction.

31. The system of claim 20, wherein the second optical train further comprises a combination of lenses selected from the group consisting of a cylindrical lens, a prism and a concave lens.

32. The system of claim 20, further comprising a processor for controlling optical communication through a select aperture of the electro-optical shutter.

33. The system of claim 32 wherein the processor communicates with the spectrometer.

34. The system of claim 32, wherein the processor is programmed with instructions to:
(a) identify a first region of interest from among the plurality of regions;
(b) identify a first aperture corresponding to the first region of interest;
(c) enable optical communication through the first aperture and block optical communication through a remainder of the plurality of apertures; and
(d) repeat steps (a) through (c) for a second region of interest.

35. The system of claim 32, wherein the processor is programmed with instructions to:
(a) identify a first region of interest and a second region of interest from among the plurality of regions;
(b) identify a first aperture corresponding to the first region of interest and a second aperture corresponding to the second region of interest; and
(c) enable optical communication through the first and the second apertures while blocking optical communication through a remainder of the plurality of apertures.

36. The system of claim 32, wherein the processor enables the first aperture independently of the second aperture.

37. The system of claim 49, wherein the first aperture and the second aperture are enabled simultaneously or sequentially.

38. The system of claim 20, further comprising an image sensor for forming a spatially accurate wavelength resolved image from a plurality of spectra collected corresponding to the plurality of sample regions.
